(19) United States
(12) Patent Application Publication
(10) Pub. No.: US 2024/0186527 A1
(43) Pub. Date: Jun. 6, 2024

(54) COPPER FOIL, ELECTRODE COMPRISING THE SAME, SECONDARY BATTERY COMPRISING THE SAME, AND METHOD FOR MANUFACTURING THE SAME

(71) Applicant: SK NEXILIS CO., LTD., Jeongeup-si Jeollabuk-do (KR)

(72) Inventors: Shan Hua JIN, Jeongeup-si Jeollabuk-do (KR); Min Seok YOON, Jeongeup-si Jeollabuk-do (KR)

(21) Appl. No.: 18/529,381

(22) Filed: Dec. 5, 2023

(30) Foreign Application Priority Data
Dec. 6, 2022 (KR) 10-2022-0168762
Oct. 5, 2023 (KR) 10-2023-0132908

(51) Int. Cl. H01M 4/66; H01M 4/75

(52) U.S. Cl. CPC H01M 4/661; H01M 4/667; H01M 4/75; H01M 2004/021

(57) ABSTRACT

According to one embodiment of the present disclosure, there is provided a copper foil including a copper film having 99.9 wt % or more of copper, wherein the copper foil has a color difference coefficient in a range of 0.38 to 0.7 based on the Lab color system.

### CROSS-REFERENCE TO RELATED APPLICATIONS

This application claims the benefit of the Korean Patent Applications No. 10-2022-0168762 filed on Dec. 6, 2022 and No. 10-2023-0132908 filed on Oct. 5, 2023, which are hereby incorporated by reference as if fully set forth herein.

### FIELD

The present disclosure relates to a copper foil, an electrode including the same, a secondary battery including the same, and a method for manufacturing the same.

### BACKGROUND

Secondary batteries are types of energy conversion devices that convert electrical energy into chemical energy, store the chemical energy therein, and then convert the chemical energy back to electrical energy when electricity is needed, thereby generating electricity. The secondary batteries are used as energy sources for electric vehicles as well as portable home appliances such as mobile phones, laptop computers, and the like. The secondary batteries are rechargeable and thus are also referred to as rechargeable batteries.

As secondary batteries that have economic and environmental advantages over disposable primary batteries, there are lead-acid batteries, nickel-cadmium secondary batteries, nickel-hydrogen secondary batteries, and lithium secondary batteries.

In particular, lithium secondary batteries may store a relatively large amount of energy relative to their size and weight compared with other secondary batteries. Accordingly, in the field of information communication devices in which portability and mobility are important, the lithium secondary batteries are preferred, and an application range thereof is also expanding to energy storage devices for hybrid vehicles and electric vehicles.

Lithium secondary batteries are repeatedly used through one cycle of charging and discharging. When a certain device is operated with a fully charged lithium secondary battery, the lithium secondary battery should have a high charge/discharge capacity in order to increase the operating time of the device. Accordingly, research to satisfy ever-increasing expectations (needs) of consumers regarding for the charge/discharge capacity of a lithium secondary battery is continuously required.

Battery characteristics of the lithium secondary battery are greatly changed according to a surface state of a copper foil used as a current collector, and thus, in order to improve yield, it is very important to improve surface characteristics of the copper foil.

In particular, when a surface roughness of the copper foil is unnecessarily high or additives are not properly added during an electroplating process, the active material is not uniformly coated, and thus, the active material is not uniformly coated due to unevenness of a surface shape of the copper foil. When the active material is non-uniformly coated on the surface of the copper foil, a short circuit may occur during charging or discharging, or a phenomenon in which the active material is delaminated from the copper foil occurs, resulting in a decrease in yield.

### SUMMARY

Accordingly, the present disclosure relates to a copper foil capable of preventing the problems caused by the limitations and disadvantages of the related art described above, an electrode including the same, a secondary battery including the same, and a method for manufacturing the same.

According to one embodiment of the present disclosure, there is provided a copper foil having a surface structure that enables uniform coating of an active material before and after stretching by having a color difference coefficient in a range of 0.38 to 0.7 based on the Lab color system.

According to another embodiment of the present disclosure, there is provided a copper foil in which factors such as surface roughness and elongation are optimized so that properties suitable for use as a current collector are imparted thereto.

According to still another embodiment of the present disclosure, there is provided an electrode for a secondary battery including the copper foil, and a secondary battery including the electrode for a secondary battery.

According to yet another embodiment of the present disclosure, there is provided a method for manufacturing a copper foil with improved charge and discharge efficiency.

In addition to the aspects of the present disclosure described above, other features and advantages of the present disclosure will be described in the following detailed description, or may be clearly understood by those skilled in the art to which the present disclosure pertains from such description.

According to one embodiment of the present disclosure, there is provided a copper foil including a copper film having 99.9 wt % or more of copper, wherein the copper foil has a color difference coefficient in a range of 0.38 to 0.7 based on the Lab color system. The color difference coefficient is calculated by Equation 1 below,

Color difference coefficient=|color difference E″ after stretching−color difference E′ before stretching| [Equation 1]

wherein the color difference (E′) before stretching of Equation 1 is calculated by Equation 2 below,

color difference (E′) before stretching=[(L*₁)²+(a*₁)²+(b*₁)²]^{1/2} [Equation 2]

wherein L*₁ in Equation 2 refers to L* before stretching, a*₁ in Equation 2 refers to a* before stretching, and b*₁ in Equation 2 refers to b* before stretching, and the color difference (E″) after stretching of Equation 1 is calculated by Equation 3 below,

color difference (E″) after stretching=[(L*₂)²+(a*₂)²+b*₂)²]^{1/2} [Equation 3]

wherein L*₂ in Equation 3 refers to L* after stretching, a*₂ in Equation 3 refers to a* after stretching, and b*₂ in Equation 3 refers to b* after stretching.

According to another embodiment of the present disclosure, there is provided a method for manufacturing a copper foil, the method including preparing an electrolyte containing copper ions, forming a copper film, and forming a protective layer on the copper film, wherein the forming of the copper film includes forming the copper film on a rotating anode drum by electrically connecting a cathode plate and the rotating anode drum, which are disposed to be spaced apart from each other in an electrolyte in an electrolytic bath, and the electrolyte includes copper ions at a concentration of 70 g/L to 100 g/L, sulfuric acid at a concentration of 70 g/L to 150 g/L, chlorine (Cl) at a concentration of 1 ppm to 3 ppm, hydrogen peroxide at a concentration of 1 ml/L to 10 ml/L, silver ions (Ag⁺) at a concentration of 0.1 ppm to 1.0 ppm, cerium ions (Ce²⁺) at a concentration of 2 ppm to 10 ppm, and lead ions (Pb²⁺) at a concentration of 1 ppm to 20 ppm.

According to still another embodiment of the present disclosure, there is provided an electrode for a secondary battery, the electrode including a copper foil and an active material layer disposed on at least one surface of the copper foil.

According to yet another embodiment of the present disclosure, there is provided a secondary battery including a cathode configured to provide lithium ions during charging, and an anode configured to provide electrons and lithium ions during discharging, an electrolyte disposed between the cathode and the anode to provide an environment in which the lithium ions are movable, and a separator configured to electrically insulate the anode and the cathode.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a cross-sectional view of a copper foil according to one embodiment of the present disclosure:

FIG. 2 is a cross-sectional view of a copper foil according to another embodiment of the present disclosure:

FIG. 3 is a cross-sectional view of an electrode for a secondary battery according to still another embodiment of the present disclosure;

FIG. 4 is a cross-sectional view of an electrode for a secondary battery according to yet another embodiment of the present disclosure:

FIG. 5 is a schematic cross-sectional view of a secondary battery according to yet another embodiment of the present disclosure; and

FIG. 6 is a device for manufacturing a copper foil according to yet another embodiment of the present disclosure.

### DETAILED DESCRIPTION

Hereinafter, embodiments of the present disclosure will be described in detail with reference to the accompanying drawings. However, the embodiments described below are presented only for illustrative purposes to facilitate a clear understanding of the present disclosure and do not limit the scope of the present disclosure.

Shapes, sizes, ratios, angles, numbers, and the like disclosed in the drawings for describing the embodiments of the present disclosure are illustrative, and thus the present disclosure is not limited to the details illustrated in the drawings. Throughout the present specification, the same components may be referred to by the same reference numerals. In describing the present disclosure, detailed descriptions of related known technologies will be omitted when it is determined that they may unnecessarily obscure the gist of the present disclosure.

When terms “including,” “having,” “consisting of,” and the like described in the present specification are used, other parts may be added unless the term “only” is used herein. When a component is expressed in the singular form, the plural form is included unless otherwise specified. In addition, in interpreting a component, it is interpreted as including an error range even when not explicitly stated.

In describing a positional relationship, for example, when a positional relationship of two parts is described as being “on,” “above,” “below, “next to,” or the like, unless “immediately” or “directly” is not used, one or more other parts may be located between the two parts.

Spatially relative terms, such as “below,” “beneath,” “lower,” “above,” “upper” and the like, may be used herein for ease of description to describe one element or component's relationship to another element(s) or component(s) as illustrated in the drawings. It will be understood that the spatially relative terms are intended to include different orientations of the element in use or operation in addition to the orientation illustrated in the drawings. For example, when an element in the drawings is turned over, an element described as being “above” or “upper” relative to another element will then be “below” or “lower” relative to the other element. Thus, the exemplary term “below” may include both above and below orientations. Likewise, the exemplary terms “above” or “upper” may include both above and below orientations.

In describing a temporal relationship, for example, when a temporal predecessor relationship is described as being “after,” “subsequent,” “next to,” “prior to,” or the like, unless “immediately” or “directly” is used, cases that are not continuous may also be included.

In order to describe various components, terms such as “first,” “second,” and the like are used, but these components are not limited by these terms. These terms are only used to distinguish one component from another component. Therefore, a first component described below may be a second component within the technical spirit of the present disclosure.

The term “at least one” should be understood to include all possible combinations from one or more related items. For example, the meaning of “at least one of first, second, and third items” may mean all combinations of two or more items of the first, second and third items as well as each of the first, second and third items.

The features of various embodiments of the present disclosure may be partially or wholly coupled to or combined with each other, and may be various technically linked or operated, and each of the embodiments may be implemented independently of each other or may be implemented together in a related relationship.

FIG. 1 is a cross-sectional view of a copper foil 110 according to one embodiment of the present disclosure.

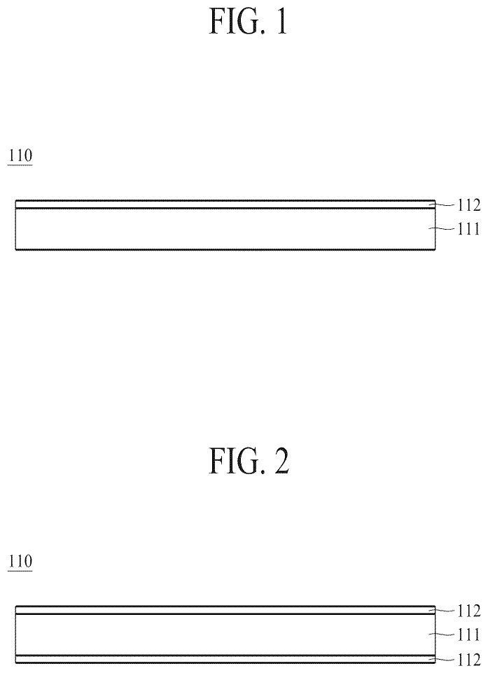

Referring to FIG. 1, the copper foil 110 of the present disclosure includes a copper film 111 including 99.9 wt % or more of copper and a protective layer 112 formed on the copper film 111. In the copper foil 110 illustrated in FIG. 1, the protective layer 112 is formed on one surface of the copper film 111, but the embodiments of the present disclosure are not limited thereto. Referring to FIG. 2, the protective layer 112 may be formed on each of both surfaces of the copper film 111.

The copper film 111 may be formed on a rotating anode drum through electroplating, and may have a shiny surface that is in direct contact with the rotating anode drum in an electroplating process and a matte surface opposite to the shiny surface.

The protective layer 112 is formed by electrodepositing an anticorrosion material on the copper film 111. The anticorrosion material may include at least one of a chromium compound, a silane compound, and a nitrogen compound. The protective layer 112 prevents oxidation and corrosion of the copper film 111 and improves heat resistance, thereby increasing a lifespan of a final product including the copper foil 110 as well as a lifespan of the copper foil 110 itself.

According to one embodiment of the present disclosure, the copper foil 110 has a color difference coefficient in a range of 0.4 to 0.7 based on the Lab color system. In this case, the color difference coefficient is calculated by Equation 1 below.

Color difference coefficient=|color difference E″ after stretching−color difference E′ before stretching| [Equation 1]

The color difference E′ before stretching of Equation 1 is calculated by Equation 2 below.

color difference (E′) before stretching=[(L*₁)²+(a*₁)²+(b*₁)²]^{1/2} [Equation 2]

L*₁ in Equation 2 refers to L*(lightness) before stretching, a*₁ in Equation 2 refers to a* before stretching, and b*₁ in Equation 2 refers to b* before stretching.

The color difference E″ after stretching in Equation 1 is calculated by Equation 3 below.

color difference (E″) after stretching=[(L*₂)²+(a*₂)²+b*₂)²]^{1/2} [Equation 3]

L*₂ in Equation 3 refers to L* after stretching, a*₂ in Equation 3 refers to a* after stretching, and b*₂ in Equation 3 refers to b* after stretching.

In Equations 1 to 3, the stretching of the copper foil 110 is performed under the condition that a width of a sample is 12.7 mm, a distance between grips is 50 mm, and a measurement speed is 50 mm/min.

A color system of the copper foil 110 is a Lab color system with L*, a*, and b* values, which are measured by a Hunter's photoelectric color difference meter, as coordinates. Based on the Lab color system, a surface of the copper foil 110 becomes white when the L* value is 100 and becomes black when the L* value is 0. In addition, the surface becomes red as the a* value increases in a positive (+) direction, and becomes green as the a* value decreases in a negative (−) direction. The surface becomes yellow as the b* value increases in the positive (+) direction, and becomes blue as the b* value decreases in the negative (−) direction.

According to one embodiment of the present disclosure, the copper foil 110 may have a color difference coefficient in a range of 0.38 to 0.7 based on the Lab color system. When the copper foil 110 according to the present disclosure has the color difference coefficient in the range of 0.38 to 0.7, the copper foil 110 may have a uniform surface structure before and after stretching, allowing the active material to be uniformly coated thereon.

On the other hand, in a case in which the color difference coefficient of the copper foil 110 is less than 0.38, when the copper foil 110 is stretched, a color difference change of the copper foil 110 before and after stretching becomes very small, and thus elongation is reduced and the copper foil 110 may be easily broken. Accordingly, the active material may not be uniformly coated. When the active material is non-uniformly coated on the surface of the copper foil 110 as a result thereof, a short circuit may occur during charging or discharging or a phenomenon in which the active material is delaminated from the copper foil may occur.

In a case in which the color difference coefficient of the copper foil 110 exceeds 0.7, when the copper foil 110 is stretched, the color difference change of the copper foil 110 before and after stretching is increased, and thus the active material may not be uniformly coated due to unevenness of a surface shape of the copper foil 110. When the active material is non-uniformly coated on the surface of the copper foil 110 as a result thereof, a short circuit may occur during charging or discharging or a phenomenon in which the active material is delaminated from the copper foil may occur.

According to one embodiment of the present disclosure, the copper foil 110 may have the color difference E′ before stretching in a range of 80 to 85.

When the color difference E′ before stretching of the copper foil 110 is less than 80, the surface shape of the copper foil 110 may become uneven, or the surface roughness may be excessively increased, and thus the active material may not be uniformly coated.

When the color difference E′ of the copper foil 110 exceeds 85, a surface area of the copper foil 110 is relatively small so that the active material is easily delaminated from the copper foil 110, and as a result, rapid lifespan deterioration of the secondary battery due to a repetition of charging and discharging is caused.

According to one embodiment of the present disclosure, the copper foil 110 may have the color difference E″ after stretching in a range of 80 to 85.

When the color difference E″ after stretching of the copper foil 110 is less than 80, since the color difference E″ after stretching is rapidly reduced as compared to the color difference E′ before stretching of the copper foil 110, the surface characteristics of the copper foil 110 are changed, and thus the active material may not be uniformly coated.

When the color difference E″ after stretching of the copper foil 110 exceeds 85, since the color difference E″ after stretching is rapidly increased as compared to the color difference E′ before stretching of the copper foil 110, the surface characteristics of the copper foil 110 are changed, and thus the active material may not be uniformly coated.

The copper foil 110 according to one embodiment of the present disclosure has a thickness of 4 μm to 35 μm. When the copper foil 110 is used as a current collector of an electrode in a secondary battery, as the thickness of the copper foil 110 becomes smaller, more current collectors can be accommodated in the same space, which is advantageous for high capacity of the secondary battery. However, the manufacture of a copper foil 110 having a thickness of less than 4 μm causes a decrease in workability.

On the other hand, when the secondary battery is manufactured with a copper foil 110 having a thickness exceeding 35 μm, it becomes difficult to realize high capacity due to the thick copper foil 110.

The copper foil 110 according to one embodiment of the present disclosure has a high-temperature elongation of 2% to 20%. The high-temperature elongation refers to an elongation measured after heat treatment at 190° C. for one hour.

In a case in which the high-temperature elongation of the copper foil 110 is less than 2%, when the copper foil 110 is subjected to a high-temperature process while being manufactured, or operated in a high-temperature condition, there is a high risk that the copper foil 110 cannot be sufficiently stretched in response to the large volume expansion of the high-capacity active material and can tear.

On the other hand, when the high-temperature elongation of the copper foil 110 exceeds 20%, due to the nature of the manufacturing process of the copper foil 110, which is conducted at high temperatures, the copper foil 110 may be easily stretched and deformation of the electrode may occur.

According to one embodiment of the present disclosure, the copper foil 110 may have an arithmetic mean roughness (Ra) of 0.1 μm to 0.3 μm.

As the secondary battery is repeatedly charged and discharged, an active material layer may alternately contract and expand, which leads to the separation of the active material layer from the copper foil 110, thus reducing the charge and discharge efficiency of the secondary battery. Accordingly, in order to secure a certain level or higher of capacity retention rate and lifespan of the secondary battery (that is, in order to suppress the deterioration of charge and discharge efficiency of the secondary battery), the bonding strength of the copper foil 110 and the active material layer should be high by allowing the copper foil 110 to have an excellent coatability on the active material.

Specifically, as the arithmetic mean roughness (Ra) of the copper foil 110 is smaller, the charge and discharge efficiency of the secondary battery including the copper foil 110 tends to be less poor. Thus, according to one embodiment of the present disclosure, the copper foil 110 has the arithmetic mean roughness (Ra) of 0.1 μm to 0.3 μm.

When the arithmetic mean roughness (Ra) of the copper foil 110 is less than 0.1 μm, the surface area of the copper foil 110 is relatively small so that the active material is easily delaminated from the copper foil 110, and as a result, rapid lifespan deterioration of the secondary battery due to a repetition of charging and discharging is caused.

On the other hand, when the arithmetic mean roughness (Ra) of the copper foil 110 exceeds 0.3 μm, a plurality of spaces exist between the copper foil 110 and the active material layer since contact uniformity between the copper foil 110 and the active material layer does not reach a predetermined level (i.e., the coating itself is partially performed), and as a result, rapid lifespan deterioration of the secondary battery due to a repetition of charging and discharging is caused.

Hereinafter, an electrode 100 including the copper foil 110 of the present disclosure and a secondary battery including the electrode 100 will be described in detail.

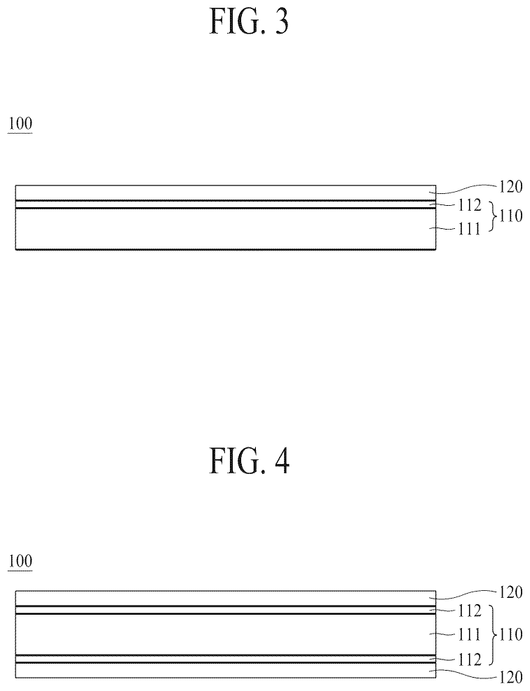

FIG. 3 is a cross-sectional view of an electrode for a secondary battery according to one embodiment of the present disclosure.

As illustrated in FIG. 3, the electrode 100 for a secondary battery according to one embodiment of the present disclosure includes the copper foil 110 of one of the above-described embodiments of the present disclosure and an active material layer 120.

FIG. 3 illustrates a configuration in which the active material layer 120 is formed on one surface of the copper foil 110. However, one embodiment of the present disclosure is not limited thereto, and referring to FIG. 4, the active material layer 120 may be formed on each of both surfaces of the copper foil 110.

Generally, in a lithium secondary battery, an aluminum foil is used as a cathode current collector combined with a cathode active material, and the copper foil 110 is used as an anode current collector combined with an anode active material.

According to one embodiment of the present disclosure, the electrode 100 for a secondary battery is an anode, the copper foil 110 is used as an anode current collector, and the active material layer 120 includes an anode active material.

In order to secure a high capacity of a secondary battery, the active material layer 120 of the present disclosure may be formed of a composite of carbon and metal. The metal may include, for example, at least one of silicon (Si), germanium (Ge), tin (Sn), lithium (Li), zinc (Zn), magnesium (Mg), cadmium (Cd), cerium (Ce), nickel (Ni), and iron (Fe), and preferably, may include Si and/or Sn.

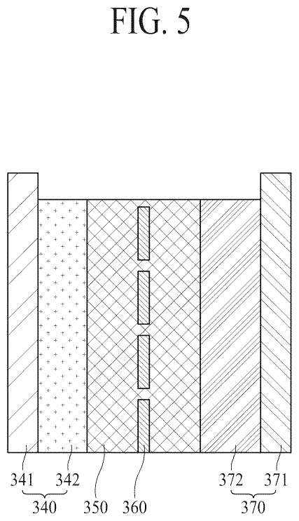

FIG. 5 is a schematic cross-sectional view of a secondary battery according to one embodiment of the present disclosure.

Referring to FIG. 5, the secondary battery includes a cathode 370, an anode 340, an electrolyte 350 disposed between the cathode 370 and the anode 340 to provide an environment in which ions can move, and a separator 360 electrically insulating the cathode 370 and the anode 340. Here, the ions moving between the cathode 370 and the anode 340 are, for example, lithium ions. The separator 360 separates the cathode 370 and the anode 340 in order to prevent charges generated at one electrode from being needlessly consumed by moving to another electrode through the inside of the secondary battery. Referring to FIG. 5, the separator 360 is disposed in the electrolyte 350.

The cathode 370 includes a cathode current collector 371 and a cathode active material layer 372, and an aluminum foil may be used as the cathode current collector 371.

The anode 340 includes an anode current collector 341 and an anode active material layer 342, and the copper foil 110 may be used as the anode current collector 341.

According to one embodiment of the present disclosure, the copper foil 110 disclosed in FIGS. 1 or 2 may be used as the anode current collector 341. In addition, the electrode 100 for a secondary battery illustrated in FIGS. 3 or 4 may be used as the anode 340 of the secondary battery illustrated in FIG. 5.

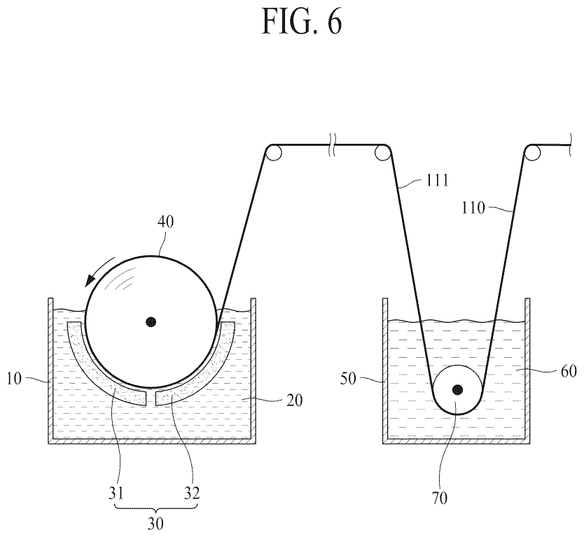

Hereinafter, a method for manufacturing the copper foil 110 of the present disclosure will be described in detail with reference to FIG. 6.

The method for manufacturing the copper foil 110 of the present disclosure includes forming a copper film 111, and forming a protective layer 112 on the copper film 111.

The method of the present disclosure includes forming the copper film 111 on a rotating anode drum 40 by electrically connecting a cathode plate 30 and the rotating anode drum 40, which are disposed to be spaced apart from each other in an electrolyte 20 in an electrolytic bath 10.

As illustrated in FIG. 6, the cathode plate 30 may include first and second cathode plates 31 and 32 electrically insulated from each other.

The forming of the copper film 111 may be performed by forming a seed layer through an electrical connection between the first cathode plate 31 and the rotating anode drum 40, and then growing a seed layer through an electrical connection between the second cathode plate 32 and the rotating anode drum 40.

A current density provided by each of the first and second cathode plates 31 and 32 may be 30 to 130 ASD (A/dm²).

When the current density provided by each of the first and second cathode plates 31 and 32 is less than 30 ASD, a surface roughness of the copper foil 110 is reduced, and thus the adhesion between the copper foil 110 and the active material layer 120 may not be sufficient.

On the other hand, when the current density provided by each of the first and second cathode plates 31 and 32 exceeds 130 ASD, a surface of the copper foil 110 may be rough, and thus the active material may not be smoothly coated.

The surface characteristics of the copper film 111 may be changed according to a buffing or polishing degree of a surface of the rotating anode drum 40. For example, the surface of the rotating anode drum 40 may be polished using a polishing brush having a grit of #800 to #3000.

In the process of forming the copper film 111, the electrolyte 20 is maintained at a temperature of 48° C. to 60° C. More specifically, the temperature of the electrolyte 20 may be maintained at 50° C. or higher. At this time, the physical, chemical, and electrical characteristics of the copper film 111 may be controlled by adjusting a composition of the electrolyte 20.

According to one embodiment of the present disclosure, the electrolyte 20 may include copper ions at a concentration of 70 g/L to 100 g/L, sulfuric acid at a concentration of 70 g/L to 150 g/L, chlorine (Cl) at a concentration of 1 ppm to 3 ppm, hydrogen peroxide (H₂O₂) at a concentration of 1 ml/L to 10 ml/L, silver ions (Ag⁺) at a concentration of 0.1 ppm to 1.0 ppm, cerium ions (Ce²⁺) at a concentration of 2 ppm to 10 ppm, and lead ions (Pb²⁺) at a concentration of 1 ppm to 20 ppm.

In order to facilitate the formation of the copper film 111 through copper electrodeposition, the concentration of copper ions and the concentration of sulfuric acid in the electrolyte 20 are adjusted in a range of 70 g/L to 100 g/L and a range of 70 g/L to 150 g/L, respectively.

In one embodiment of the present disclosure, the chlorine (Cl) includes all of chlorine ions (Cl—) and chlorine atoms present in a molecule. The chlorine (Cl) may, for example, be used to remove silver (Ag) ions input into the electrolyte 20 in a process of forming the copper film 111. Specifically, the chlorine (Cl) may precipitate silver (Ag) ions in the form of silver chloride (AgCl). The silver chloride (AgCl) may be removed through filtration.

When the concentration of chlorine (Cl) is less than 1 ppm, the silver (Ag) ions are not removed well. On the other hand, when the concentration of chlorine (Cl) exceeds 3 ppm, an unnecessary reaction due to excessive chlorine (Cl) may occur, the copper film 111 that is electrodeposited on the rotating anode drum 40 may have a surface with sharp protrusions, and this surface provides an excellent environment for crystals to expand when the copper foil 110 is heat-treated. As a result, the color difference coefficient may fall outside the range of 0.38 to 0.7 due to a defect in the surface state of the copper foil 110. According to one embodiment of the present disclosure, the electrolyte 20 including an organic additive may further include hydrogen peroxide (H₂O₂). Due to the organic additive, organic impurities may be present in the electrolyte 20 that is continuously plated, and a content of carbon (C) in the copper foil may be appropriately adjusted by decomposing the organic impurities by treating the organic impurities with hydrogen peroxide (H₂O₂). As a concentration of total organic carbon (TOC) in the electrolyte 20 is increased, an amount of carbon (C) elements input into the copper film 111 is increased, which causes an increase in total amount of elements detached from the copper film 111 during heat treatment and thus causes a decrease in strength of the copper foil 110 after heat treatment.

The hydrogen peroxide (H₂O₂) is added in an amount of 1 ml to 10 ml per one L of the electrolyte. Specifically, the hydrogen peroxide (H₂O₂) may be added in an amount of 2 ml to 8 ml per one L of the electrolyte. When the amount of added hydrogen peroxide (H₂O₂) is less than 1 ml/L, it is meaningless because there is little effect on the decomposition of organic impurities. When the amount of added hydrogen peroxide (H₂O₂) exceeds 10 ml/L, the organic impurities are excessively decomposed, and thus, the effect of inorganic additives such as cerium ions (Ce²⁺) is suppressed.

According to one embodiment of the present disclosure, the content of silver ions (Ag⁺) in the electrolyte 20 is 0.1 ppm to 1.0 ppm.

When the concentration of silver ions (Ag⁺) included in the electrolyte 20 is less than 0.1 ppm, the surface state of the copper foil 110 may become excessively poor, and thus, the color difference coefficient may fall outside the range of 0.38 to 0.7.

When the concentration of silver ions (Ag⁺) included in the electrolyte 20 exceeds 1.0 ppm, the surface state of the copper foil 110 may become excessively poor, and thus, the color difference coefficient may fall outside the range of 0.38 to 0.7.

According to one embodiment of the present disclosure, the content of cerium ions (Ce²⁺)in the electrolyte 20 is 2 ppm to 10 ppm.

When the content of cerium ions (Ce²⁺)in the electrolyte 20 is less than 2 ppm, the tensile strength of the copper foil 110 is lowered, and when a final product with the copper foil 110 is manufactured through a roll-to-roll process, the risk of folding/curling is increased. In addition, the surface state of the copper foil 110 becomes poor, and as a result, the color difference coefficient may fall outside the range of 0.38 to 0.7.

On the other hand, when the content of cerium ions (Ce²⁺) in the electrolyte 20 exceeds 10 ppm, the improvement in terms of surface characteristics does not occur proportionally with the increase in the content of cerium ions (Ce²⁺). Thus, by adjusting the content of cerium ions (Ce²⁺)in the electrolyte 20 to the range of 2 ppm to 10 ppm, the performance of the copper foil 110 relative to manufacturing costs can be maximized.

According to one embodiment of the present disclosure, the electrolyte 20 including an organic additive may further include 1 ppm to 20 ppm of lead ions (Pb²⁺). The lead ions (Pb²⁺) in the electrolyte 20 are managed at a concentration of 1 ppm to 20 ppm. In order to maintain the concentration of lead ions (Pb²⁺), a material that does not include lead (Pb) may be used as a raw material input to the electrolyte 20.

When the concentration of lead ions (Pb²⁺) is less than 1 ppm, a problem may occur where effectiveness is reduced in terms of maintaining the physical properties of the present disclosure. Accordingly, the color difference coefficient may fall outside the range of 0.38 to 0.7.

When the concentration of lead ions (Pb²⁺) exceeds 20 ppm, the lead ions (Pb²⁺) should be removed from the electrolyte 20 by using an ion exchange filter, and the surface roughness may be significantly increased because copper is non-uniformly precipitated, and thus, the active material may not be uniformly coated on the copper foil 110. As a result, the color difference coefficient may fall outside the range of 0.38 to 0.7.

When the copper film 111 is formed, a flow rate of the electrolyte 20 supplied into the electrolytic bath 10 may be 41 m³/hour to 45 m³/hour.

The forming of the copper film 111 may include at least one of filtering the electrolyte 20 using activated carbon, filtering the electrolyte 20 using diatomaceous earth, and treating the electrolyte 20 with ozone (O₃).

Specifically, the cleanliness of the electrolyte 20 may be maintained or improved by treating the electrolyte 20 with ozone or by inputting hydrogen peroxide and air into the electrolyte 20 while forming the copper film 111 through electroplating. The cleanliness of the electrolyte 20 may also be maintained or improved by filtering the electrolyte 20 through a high-purity carbon having a TOC of less than 3 ppm to minimize organic impurities in the electrolyte 20.

In addition, the cleanliness of the electrolyte 20 may be maintained or improved by filtering the electrolyte 20 through high purity diatomaceous earth having a TOC of less than 5 ppm.

In addition, in order to maintain the cleanliness of the electrolyte 20, a copper (Cu) wire used as a raw material for the electrolyte 20 may be cleaned.

According to one embodiment of the present disclosure, preparing the electrolyte 20 may include heat-treating a Cu wire, acid-cleaning the heat-treated Cu wire, water-cleaning the acid-cleaned Cu wire, and inputting the water-cleaned Cu wire into sulfuric acid for an electrolyte.

More specifically, in order to maintain the cleanliness of the electrolyte 20, a Cu wire with a high purity (99.9% or more) is heat-treated in an electric furnace at a temperature of 750° C. to 850° C. to burn various organic impurities attached to the Cu wire, the heat-treated Cu wire is acid-cleaned using a 10% sulfuric acid solution for 10 to 20 minutes, and the acid-cleaned Cu wire is then water-cleaned using distilled water, thereby preparing copper for manufacturing the electrolyte 20. The water-cleaned Cu wire may be input into sulfuric acid for an electrolyte to prepare the electrolyte 20.

According to one embodiment of the present disclosure, in order to satisfy the characteristics of the copper foil 110, a concentration of TOC in the electrolyte 20 is controlled to be 10 ppm or less. That is, the electrolyte 20 may have a TOC concentration of 10 ppm or less.

The copper film 111 thus prepared may be cleaned in a cleaning bath.

For example, an acid cleaning process for removing impurities on a surface of the copper film 111, for example, resin components or natural oxides, and a water cleaning process for removing acidic solutions used for the acid cleaning may be sequentially performed. The cleaning process may be omitted.

Next, the protective layer 112 is formed on the copper film 111.

Referring to FIG. 6, the method may further include immersing the copper film 111 in an anticorrosion solution 60. When the copper film 111 is immersed in the anticorrosion solution 60, the copper film 111 may be guided by a guide roll 70 disposed in the anticorrosion solution 60.

As described above, the anticorrosion solution 60 may include at least one of a chromium compound, a silane compound, and a nitrogen compound. For example, the copper film 111 may be immersed in a 1 g/L to 10 g/L potassium dichromate solution at room temperature for 1 to 30 seconds.

Meanwhile, the protective layer 112 may include a silane compound by silane treatment or a nitrogen compound by nitrogen treatment.

The copper foil 110 is formed by forming the protective layer 112.

At least one anode active material selected from the group consisting of carbon, a metal (Me) of Si, Ge, Sn, Li, Zn, Mg, Cd, Ce, Ni or Fe, an alloy including the metal (Me), an oxide (MeOₓ) of the metal (Me), and a composite of the metal (Me) and carbon is coated on one surface or both surfaces the copper foil 110 of the present disclosure prepared through the method as described above to manufacture an electrode (i.e., anode) for a secondary battery of the present disclosure.

For example, 100 parts by weight of carbon for an anode active material, 1 to 3 parts by weight of styrene butadiene rubber (SBR), and 1 to 3 parts by weight of carboxymethyl cellulose (CMC) are mixed and prepared as a slurry using distilled water as a solvent. Subsequently, the slurry is applied on the copper foil 110 to a thickness of 20 μm to 60 μm using a doctor blade and pressed at 110° C. to 130° C. and at a pressure of 0.5 to 1.5 ton/cm².

A secondary battery may be manufactured using the electrode (anode) for a secondary battery of the present disclosure manufactured through the method as described above, together with a conventional cathode, electrolyte and separator.

Hereinafter, the present disclosure will be described in detail with reference to examples and comparative examples. However, the examples described below are only intended to aid understanding of the present disclosure, and the scope of the present disclosure is not limited to these examples.

### EXAMPLES 1 TO 5 AND COMPARATIVE EXAMPLES 1 TO 5

A copper foil was prepared using a foil maker including an electrolytic bath 10, a rotating anode drum 40 disposed in the electrolytic bath 10, and a cathode plate 30 disposed to be spaced apart from the rotating anode drum 40. An electrolyte 20 was a copper sulfate solution. A concentration of copper ions in the electrolyte 20 was set to 88 g/L, a concentration of sulfuric acid was set to 105 g/L, a temperature of the electrolyte was set to 55° C., and a current density was set to 50 ASD

In addition, concentrations of chlorine (CI), hydrogen peroxide (H₂O₂), cerium ions (Ce²⁺), and lead ions (Pb²⁺) included in the electrolyte 20 are as shown in Table 1 below.

A current at a current density of 50 ASD was applied between the rotating anode drum 40 and the cathode plate 30 to prepare a copper film 111. Thereafter, the copper film 111 was immersed in an anticorrosion solution for about two seconds to perform chromate treatment on the surface of the copper film 111 to form a protective layer 112, thereby preparing a copper foil 110. An anticorrosion solution containing chromic acid as a main component was used as the anticorrosion solution, and a concentration of chromic acid was 5 g/L.

As a result, copper foils of Examples 1 to 5 and Comparative Examples 1 to 5 were prepared.

TABLE 1

| | Electrolyte | | | | | | | | |
|---|---|---|---|---|---|---|---|---|---|
| | | Sulfuric | | Hydrogen | | | | Current | Electrolyte |
| | Cu | acid | Chlorine | peroxide | Ag⁺ | Ce²⁺ | Pb²⁺ | density | temperature |
| | (g/L) | (g/L) | (ppm) | (ml/L) | (ppm) | (ppm) | (ppm) | (ASD) | (° C.) |
| Example 1 | 88 | 105 | 2.0 | 5.0 | 0.5 | 3.2 | 5.0 | 50 | 55 |
| Example 2 | 88 | 105 | 2.2 | 7.0 | 0.6 | 3.2 | 5.0 | 50 | 55 |
| Example 3 | 88 | 105 | 1.8 | 7.0 | 0.8 | 5 | 10 | 50 | 55 |
| Example 4 | 88 | 105 | 2.5 | 3.0 | 0.3 | 3.2 | 15 | 50 | 55 |
| Example 5 | 88 | 105 | 2.0 | 5.0 | 0.3 | 7 | 17 | 50 | 55 |
| Comparative | 88 | 105 | 0.1 | 0.5 | 1.5 | 3.2 | 10 | 50 | 55 |
| Example 1 | | | | | | | | | |
| Comparative | 88 | 105 | 2.0 | 5.0 | 0.5 | 15 | 50 | 50 | 55 |
| Example 2 | | | | | | | | | |
| Comparative | 88 | 105 | 2.0 | 15 | 0.5 | 0.1 | 10 | 50 | 55 |
| Example 3 | | | | | | | | | |
| Comparative | 88 | 105 | 5.0 | 5.0 | 0.5 | 15 | 10 | 50 | 55 |
| Example 4 | | | | | | | | | |
| Comparative | 88 | 105 | 0.2 | 5.0 | 1.3 | 3.2 | 0.1 | 50 | 55 |
| Example 5 | | | | | | | | | |

TABLE 2

| | | | | | | | Color | Color | | |
|---|---|---|---|---|---|---|---|---|---|---|
| | Chroma value | | | Chroma value | | | difference | difference | Color | |
| | before stretching | | | after stretching | | | E′ before | E″ after | difference | |
| | L*₁ | a*₁ | b*₁ | L*₂ | a*₂ | b*₂ | stretching | stretching | coefficient | Coating |
| Example 1 | 78.78 | 18.46 | 17.88 | 78.09 | 18.42 | 18.15 | 82.86 | 82.26 | 0.60 | Good |
| Example 2 | 76.94 | 19.87 | 19.25 | 76.24 | 19.51 | 19.48 | 81.76 | 81.07 | 0.69 | Good |
| Example 3 | 78.47 | 18.53 | 18.10 | 78.01 | 18.45 | 18.40 | 82.63 | 82.25 | 0.39 | Good |
| Example 4 | 79.81 | 18.12 | 17.46 | 79.45 | 17.72 | 17.50 | 83.68 | 83.26 | 0.42 | Good |
| Example 5 | 77.92 | 19.10 | 18.53 | 77.47 | 18.74 | 18.60 | 82.34 | 81.85 | 0.49 | Good |
| Comparative | 85.11 | 13.90 | 16.80 | 85.40 | 14.47 | 16.72 | 87.86 | 88.22 | 0.36 | Bad |
| Example 1 | | | | | | | | | | |
| Comparative | 82.80 | 17.47 | 18.37 | 83.05 | 17.49 | 17.61 | 86.59 | 86.68 | 0.09 | Bad |
| Example 2 | | | | | | | | | | |
| Comparative | 82.60 | 17.27 | 18.27 | 82.90 | 17.45 | 18.10 | 86.34 | 86.63 | 0.29 | Bad |
| Example 3 | | | | | | | | | | |
| Comparative | 74.85 | 16.55 | 18.12 | 75.02 | 17.10 | 17.98 | 78.77 | 79.02 | 0.25 | Bad |
| Example 4 | | | | | | | | | | |
| Comparative | 73.40 | 16.87 | 17.79 | 74.01 | 17.62 | 17.72 | 77.39 | 78.11 | 0.73 | Bad |
| Example 5 | | | | | | | | | | |

For the copper foils prepared according to Examples 1 to 5 and Comparative Examples 1 to 5 as described above, i) chroma values L*₁, a*₁, and b*₁ before stretching, ii) chroma values L*₂, a*₂, and b*₂ after stretching, iii) color difference E′ before stretching, iv) color difference E″ after stretching, v) color difference coefficient, and vi) coatability were checked.

Measurement of i) chroma value before stretching and ii) chroma value after stretching

The chroma value before stretching of the copper foil 110 refers to a chroma value measured before stretching.

The chroma value after stretching of the copper foil 110 refers to a chroma value measured after stretching.

Here, the stretching of the copper foil 110 is performed under the condition that a width of a sample is 12.7 mm, a distance between grips is 50 mm, and a measurement speed is 50 mm/min.

L*₁, a*₁, and b*₁ of the Lab color system were measured in accordance with ASTM E1164 using a Model CM-5 manufactured by Konica Minolta, Inc. as a measuring device.

Conditions of the measuring device are as follows.
Light source: xenon lamp D65
Viewing angle: 10°
Wavelength range: 360 nm to 740 nm
Wavelength interval: 10 nm
Reference: air
L*₂, a*₂, and b*₂ were measured by the same method as L*₁, a*₁, and b*₁ after stretching described above.

Calculation of iii) color difference E′ before stretching and iv) color difference E″ after stretching

Color difference E′ before stretching is calculated by Equation 2 below using the measured L*₁, a*₁, and b*₁.

color difference (E′) before stretching=[(L*₁)²+(a*₁)²+(b*₁)²]^{1/2} [Equation 2]

Color difference E″ after stretching is calculated by Equation 3 below using the measured L*₂, a*₂, and b*₂.

color difference (E″) after stretching=[(L*₂)²+(a*₂)²+b*₂)²]^{1/2} [Equation 3]

### v) Calculation of Color Difference Coefficient

The color difference coefficient is calculated by Equation 1 below using the

measured color difference E′ before stretching and color difference E″ after stretching.

Color difference coefficient=|color difference E″ after stretching−color difference E′ before stretching| [Equation 1]

### vi) Coatability

Slide glass was attached to one surface of double-sided tape, and an active material portion of an anode for a secondary battery is attached to the other surface of the double-sided tape. After fixing the slide glass to a lower portion of a universal testing machine (UTM), an adhesion was measured while peeling off the copper foil.
Measurement tester: UTM
Sample width: 12.7 mm
Measurement type: 180° peel test
Measurement speed: 50 mm/min

After evaluating the coatability, the copper foil was marked as “good” when it was determined to be suitable as an anode current collector of an electrode for a secondary battery, and “poor” when it was determined unsuitable.

Referring to Tables 1 and 2, the following results may be confirmed.

It may be confirmed that the copper foil of Comparative Example 1 prepared using an electrolyte including chlorine ions and hydrogen peroxide in small amounts and silver ions in an excessive amount has poor adhesion to the active material.

It may be confirmed that the copper foil of Comparative Example 2 prepared using an electrolyte including cerium ions and lead ions in excessive amounts has poor adhesion to the active material.

It may be confirmed that the copper foil of Comparative Example 3 prepared using an electrolyte including hydrogen peroxide in an excessive amount and cerium ions in a small amount has poor adhesion to the active material.

It may be confirmed that the copper foil of Comparative Example 4 prepared using an electrolyte including chlorine ions and cerium ions in excessive amounts has poor adhesion to the active material.

It may be confirmed that the copper foil of Comparative Example 5 prepared using an electrolyte including chlorine ions and the lead ions (Pb2+) in small amounts and silver ions in an excessive amount has poor adhesion to the active material.

On the other hand, all the copper foils of Examples 1 to 5 according to the present disclosure satisfied with values within the above standard ranges, and as a result, it may be confirmed that the adhesion between the copper foil and the active material is normal.

According to one embodiment of the present disclosure, it is possible to provide a copper foil having a surface structure that enables uniform coating of an active material before and after stretching by having a color difference coefficient in a range of 0.38 to 0.7 based on the Lab color system, an electrode for a secondary battery capable of exhibiting excellent stability by including the same, and a secondary battery including the electrode.

It will be apparent to those skilled in the art that the present disclosure described above is not limited by the above-described embodiments and the accompanying drawings and that various substitutions, modifications, and variations can be made in the present disclosure without departing from the spirit and scope of the present disclosure. Accordingly, the scope of the present disclosure is defined by the accompanying claims, and it is intended that all variations and modifications derived from the meaning, scope, and equivalent concept of the claims fall within the scope of the present disclosure.

### DESCRIPTION OF REFERENCE NUMERALS

100: electrode for second battery
110: copper foil
111: copper film
120: active material layer
10: electrolytic bath
20: electrolyte

What is claimed is:

1. A copper foil comprising a copper film including 99.9 wt % or more of copper,
wherein the copper foil has a color difference coefficient in a range of 0.38 to 0.7 based on the Lab color system,
wherein the color difference coefficient is calculated by Equation 1 below,
Color difference coefficient=|color difference E″ after stretching−color difference E′ before stretching| [Equation 1]
wherein the color difference (E′) before stretching of Equation 1 is calculated by Equation 2 below,
color difference (E′) before stretching=[(L*₁)²+(a*₁)²+(b*₁)²]^{1/2} [Equation 2]
wherein L*₁ in Equation 2 refers to L*₁ before stretching,
a*₁ in Equation 2 refers to a* before stretching, and
b*₁ in Equation 2 refers to b* before stretching, and
the color difference (E″) after stretching of Equation 1 is calculated by Equation 3 below,
color difference (E″) after stretching=[(L*₂)²+(a*₂)²+b*₂)²]^{1/2} [Equation 3]
wherein L*₂ in Equation 3 refers to L*₁ after stretching,
a*₂ in Equation 3 refers to a* after stretching, and
b*₂ in in Equation 3 refers to b* after stretching.

2. The copper foil of claim 1, wherein the color difference (E′) before stretching is in a range of 80 to 85.

3. The copper foil of claim 1, wherein the color difference (E″) after stretching is in a range of 80 to 85.

4. The copper foil of claim 1, wherein the copper foil has a high-temperature elongation of 2% to 20%, wherein the high-temperature elongation is an elongation measured after heat treatment at 190° C. for one hour.

5. The copper foil of claim 1, wherein the copper foil has an arithmetic mean roughness (Ra) of 0.1 μm to 0.3 μm.

6. The copper foil of claim 1, further comprising a protective layer formed on the copper film.

7. The copper foil of claim 6, wherein the protective layer includes at least one of a chromium compound, a silane compound, and a nitrogen compound.
